(19) United States
(12) Patent Application Publication
(10) Pub. No.: US 2012/0186155 A1
(43) Pub. Date: Jul. 26, 2012

(54) PASSIVE WATER SUPPLY SYSTEM FOR PLANT POT

(76) Inventor: CHIN-TAI TSAI, Taichung City (TW)

(21) Appl. No.: 13/244,515

(22) Filed: Sep. 25, 2011

(30) Foreign Application Priority Data
Jan. 25, 2011 (TW) 100120263
Jul. 12, 2011 (TW) 100124524

(51) Int. Cl. A01G 9/02

(52) U.S. Cl. 47/79

(57) ABSTRACT

A pot assembly includes a pot having an inner part with a recessed space and a transparent outer part which supports the inner part. A hollow area is defined between the inner and outer parts. The inner and outer parts are connected to each other by two respective connection parts. The inner bottom of the space has a recess and a hole is defined through the inside of the recess and communicates with the hollow area. A water-guide member is located in the recess and the other end of the water-guide member is located adjacent to conjunction area between the hole and the hollow area. The water-guide member includes multiple particles and liquid spreads in the soil in the space via the paths between adjacent particles. A hollow hose is connected to the inner or outer parts for communication between the air inside and outside of the hollow area.

### FIELD OF THE INVENTION

The present invention relates to a hollow pot, and more particularly, to a hollow pot with a passive water supply system.

### BACKGROUND OF THE INVENTION

The conventional pot for plants generally is made by ceramic or plastic which is made integrally by way of mold injection and includes a single layer, and a recessed area is defined in the center thereof and a hole is defined through the bottom of the pot. The soil is filled in the recessed area and the exceed water in the soil can escape from the hole in the bottom of the pot so that the soil is maintained in suitable water for providing good conditions for the plants in the pot.

However, during the growing process of the plant in the pot, the owner has to water proper amount of water to the plant. Most of the owners believe that more water supplied to the plants is better than less water so that usually much more than needed amount of water and the soil flow from the hole of the pot. The soil and water make the floor messy and the soil flows from the pot quickly.

Furthermore, urban people live in high rise buildings so that the watering to the plants may cause water drop to the lower floors and this generally generates noise and the neighbors lived in the low floors may feel upset by the leaking water and soil.

The conventional pot has only one layer so that the heat from the sunshine is directly transferred to the plant of the pot so that the temperature and humidity at the bottom of the pot is too high so that the roots of the plants easily die.

When the owners travel away from homes, the plants can easily die because of lack of water.

The present invention intends to provide a hollow pot with a water supply system to improve the shortcomings mentioned above.

### SUMMARY OF THE INVENTION

The present invention relates to a pot assembly and comprises an inner part with a first connection portion which is located outside of the recessed space in the inner part, and the first connection portion is connected to a second connection portion of a transparent outer part which supports the inner part. A hollow area is defined between the inner and outer parts. The recessed space has a recess defined in the inner bottom thereof and a hole is defined through the bottom of the recess and communicates with the hollow area. A water-proof unit is located in the recess and has one end reaches into the hollow area.

The outer part is a recessed transparent part and has the second connection portion which is connected to the first connection portion of the inner part.

A water-proof unit is clamped between the inner and outer parts so as to seal the top portion of the hollow area.

A hollow hose is connected to the inner part or the outer part, wherein a top end of the hollow hose communicates with outside of the hollow area and a lower end of the hollow hose communicates with the hollow area. Air of outside of the hollow area is in communication with the air in the interior of the hollow area.

The water-guide member comprises multiple particles which are made by way of sintering, and irregular paths are defined between adjacent particles. Liquid spreads in the soil in the space via the irregular paths.

The present invention supplies water to the soil so as to adjust the humidity of the soil within a long term of time such that the roots of the plants are not rotten. The hollow area of the pot assembly is used as a water storage area and the water can be spread and guided into the soil in a small amount to keep the soil wet so that the owners do not need to water the plants frequently. This allows the owners of the plants to travel away from home for a period of time without worry of watering of the plants.

The transparent outer part has the over-flow index area on the outside thereof and the sun rays directly enter the hollow area so that the maximum level of water, the humidity of the soil, the growth of the plants and the way of the water flow can be visible by the owners. Aquatic plants and animals can be raised in the hollow area to achieve aesthetic purposes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pot assembly of the present invention;

FIG. 2 is a cross sectional view of the pot assembly of the present invention;

FIG. 3 is a partial enlarged cross sectional view of the pot assembly of the present invention in FIG. 2;

FIG. 4 is a cross sectional view to show a way of use of the pot assembly of the present invention;

FIG. 5 is a cross sectional view to show parts of the pot assembly of the present invention;

FIG. 6 shows water is poured into the outer part of the pot assembly of the present invention;

FIG. 7 is a cross sectional view of the pot assembly of the present invention when water is supplied to the pot assembly;

FIG. 8 is a partial enlarged cross sectional view of the pot assembly of the present invention in FIG. 7;

FIG. 9 is a perspective view to show the pot assembly of the present invention in FIG. 7;

FIG. 10 is a perspective view to show the second embodiment of the pot assembly of the present invention, and

FIG. 11 is a cross sectional view to show the third embodiment of the pot assembly of the present invention.

### DETAILED DESCRIPTION OF THE PREFERRED EMBODIMENT

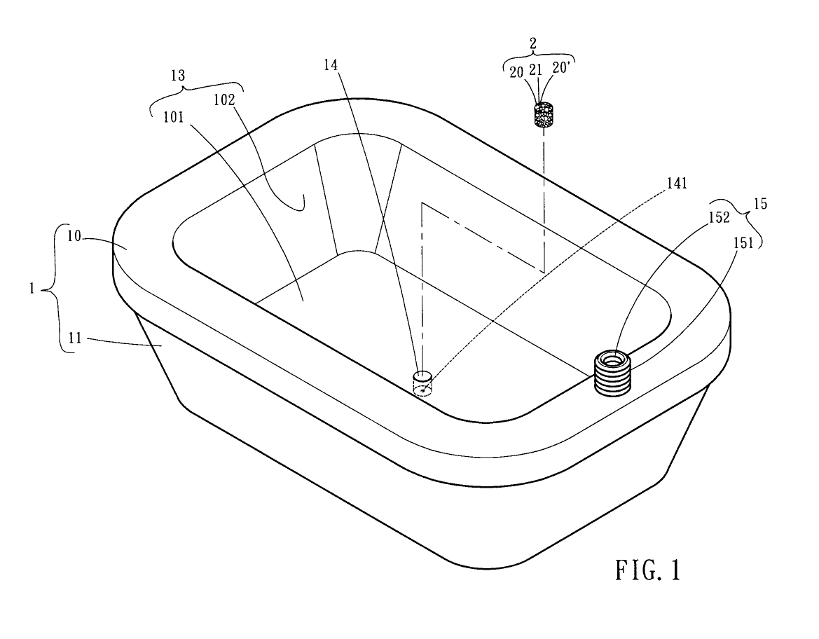

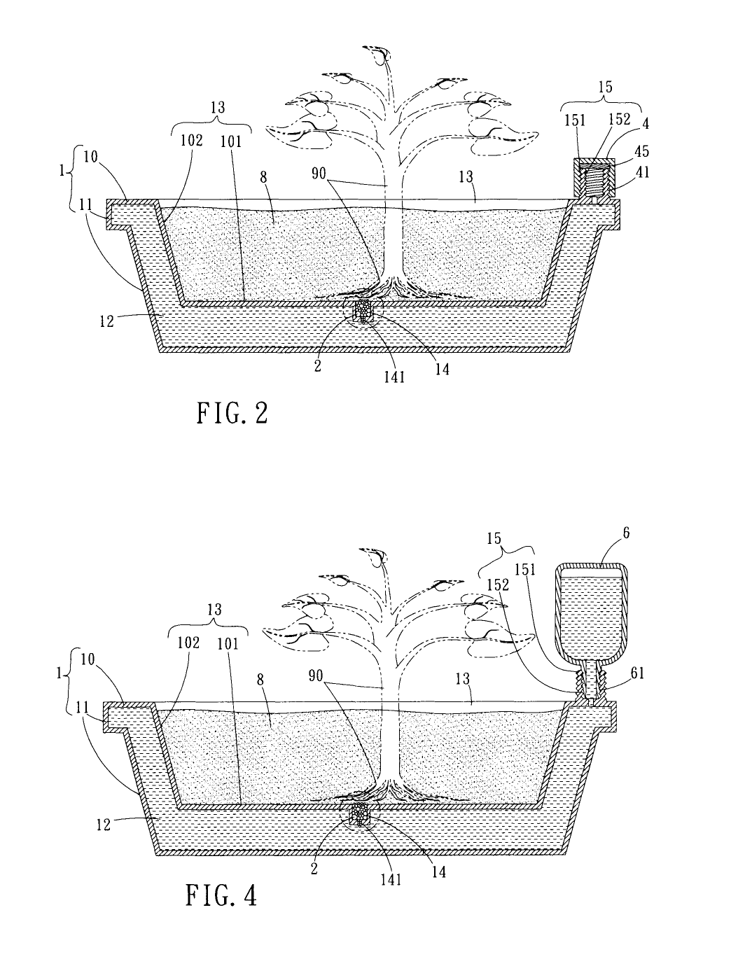

Referring to FIGS. 1 to 4, the pot assembly of the present invention comprises a pot 1 and a water-guide member 2, wherein the pot 1 has an inner part 10 with a recessed space 13 defined therein and an outer part 11 which supports the inner part 10. A hollow area 12 is defined between the inner and outer parts 10, 11, and a water-supply unit 15 is connected to the hollow area 12. The space 13 is defined by the convex inner bottom 101, the periphery 102 and the U-shaped inside 103, and the convex inner bottom 101 is a protrusion surrounded by the U-shaped inside 103. The convex inner bottom 101 has a downward recess 14 with one stage or multiple stages. More than one hole 141 is located at a position of the space 13 and communicates with the hollow area 12. The inside of the recess 14 is located outside of the water-guide member 2 so that the hole 141 communicates between the recess 14 or the space 13 and the hollow area 12. An end of the water-guide member 2 extends through the hole 141 and the water-guide member 2 comprises multiple particles 20, 20′. In other words, the end of the water-guide member 2 extends to the bottom of the hole 141 or protrudes from the bottom of the hole 141. Preferably, the end of the water-guide member 2 extends over the bottom of the hole 141 and reaches into the hollow area 12. The lowest position of the recess 14 or the hole 141 is located at the inside of the horizontal line of the lowest position of the U-shaped inside 103, or slightly protrudes beyond the inside of the horizontal line of the lowest position of the U-shaped inside 103 about 10 mm, so that the recess 14 or the hole 141 is hidden. The water-supply unit 15 is a hollow unit and has one end extends through the inner pat 10 or the outer part 11, and communicates with the hollow area 12. The water-supply unit 15 has a locking portion 151 and inner threads 152 at an inside thereof so that the seal unit 4 (including cover or cap) can be threadedly to the outside of inside of the water-supply unit 15 respectively. A sealing member 45 (such as a washer or gasket) is located between the seal unit 4 and the water-supply unit 15. Therefore, the hollow area 12 is sealed by the seal unit 4 (such as the cover in FIG. 2 and the cap in FIG. 4) and the sealing member 45. The locking portion 151 can be hooked or spiral shape. The inner part 10 and the outer part 11 of the pot 1 are integrally connected to each other by way of blow molding as shown in FIGS. 2 and 4, or by way of blow-mounting-molding, or the two parts 10, 11 are individually made and then connected to each other.

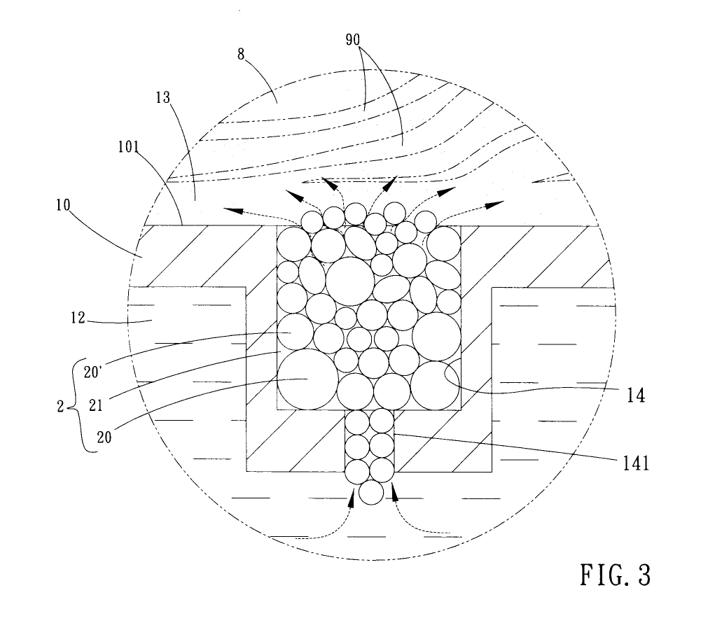

The water-guide member 2 comprises multiple particles 20, 20′ which are made by way of sintering. Irregular paths 21 are defined between adjacent particles 20, 20′. The particles 20, 20′ are not rotten in the water such as metal particles (such as iron particles, silver particles, Tin particles, and copper particles). Stone particles, ceramic particles are also available. The copper particles 20, 20′ are preferable. As shown in FIG. 3, the outer surface or inside of the water-guide member 2 comprises multiple metal particles, preferable copper particles, which are made by way of sintering. Irregular paths 21 are defined between adjacent particles 20, 20′. The water-guide member 2 is located in the recess 14 between the space 13 and the hollow area 12. An end of the water-guide member 2 extends through the conjunction area between the hole 141 and the hollow area 12, or the end of the water-guide member 2 extends through the hole 141 and reaches into the hollow area 12. Liquid in the hollow area 12 slowly spreads upward into the soil 8 in the space 13 by way of the surface tension and the paths 21.

The seal unit 4 is an individual unit and has inner threads 41 (or hooks) defined in the inside thereof and the sealing member 45 is located at the bottom of the seal unit 4. The seal unit 4 is connected to the water-supply unit 15 by the inner threads 41 and the sealing member 45 is firmly clamped between the end surface of the water-supply unit 15 and the seal unit 4.

When planting the plant 90, the metal water-guide member 2 is installed in the hole 141 in the recess 14 and the other end of the water-guide member 2 extend through the hole 141 and reaches into the hollow area 12, so that the water-guide member 2 is located at water traces between the space 13 and the at least one hole 141. Because the water-guide member 2 comprises multiple metal (copper) particles 20, 20′ which are made by way of sintering and have irregular paths 21 defined between adjacent particles 20, 20′, so that the hollow area 12 and the space 13 are in communication with each other. Soil 8 is poured into the space 13 and the plant 90 is planted into the soil 8. Watering the soil 8 and the water spreads the soil 8 and is eventually collected in the hallow area 12 so that the exceed water in the soil 8 flows into the hollow area 12 via the paths 21 between the particles 20, 20′. The exceed water is stored in the hollow area to adjust the humidity of the soil 8 and does not leak.

Water can also be poured into the hollow area 12 via the water-supply unit 15 until the surface of the water in the hollow area 12 reaches the bottom of the recess 14. The water enters into the soil 8 by way of surface tension via the hole 141 and the paths 21 of the water-guide member 2. The water slowly spreads the soil via the hole and the paths 21 and fills the area between the recess 14 and the water-guide member 2. The soil 8 located close to the surface of the water-guide member 2 is slightly wet. When water is continuously supplied from the water-supply unit 15, the surface of the water in the hollow area 12 raises until the surface reaches the maximum position. The inner threads 41 (the cover in FIG. 2) or the outer threads 42 (the cap in FIG. 4) of the seal unit 4 is threadedly connected to the locking portion 151 or the inner threads 152 to let the seal unit 4 properly connected to the water-supply unit 15.

Because the seal unit 4 and the water-supply unit 15 are not completely sealed, small amount of air enters from the gaps between the seal unit 4 and the water-supply unit 15. Therefore, the small amount of air applies a pressure to the water surface in the hollow area 12 so as to force the water molecular slowly flows into the soil 8 via the gaps between the hole 141 and the water-guide member 2, until the soil 8 cannot absorb more water. In other words, the water molecular can be automatically supplied to the soil 8 via the gaps between the hole 141 and the water-guide member 2, and this keeps the plant alive even if the owners travel way from home for a period of time.

Furthermore, irregular paths 21 are defined between adjacent particles 20, 20′ of the water-guide member 2 and the multiple metal particles (copper particles) are made by way of sintering. These particles are not rotten in the water and the paths 21 are not stocked by the soil 8 so that the paths 21 are ensured to be functioned properly to keep the humidity of the soil 8 in the space 13 and filter the water passing through the paths 21.

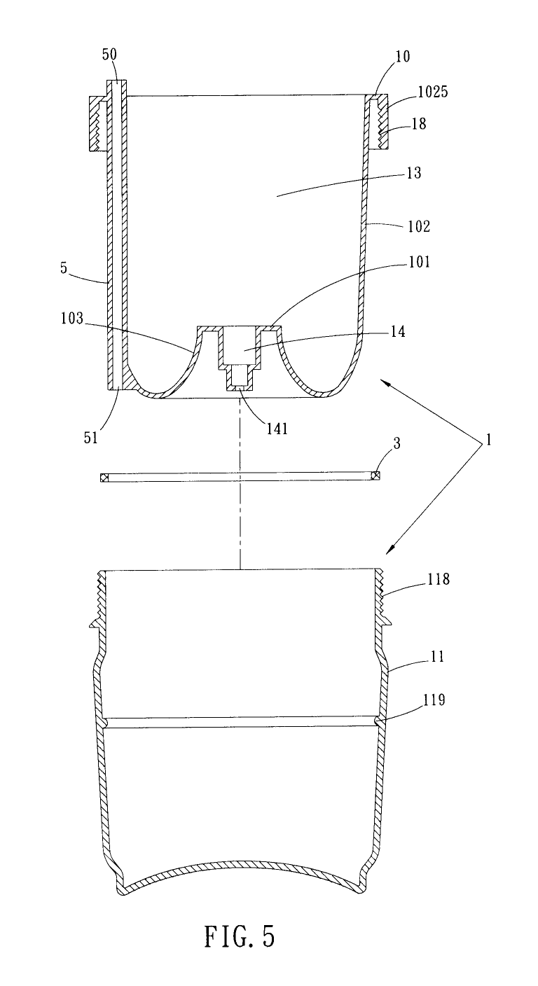

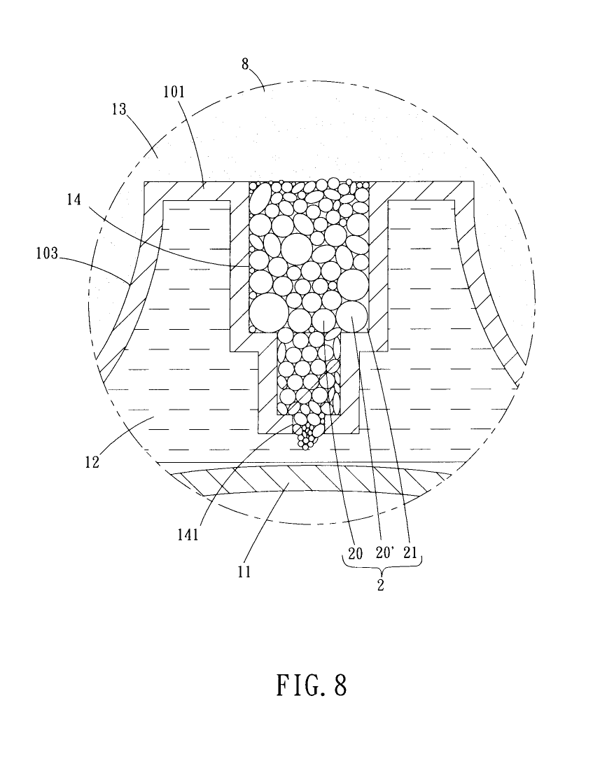

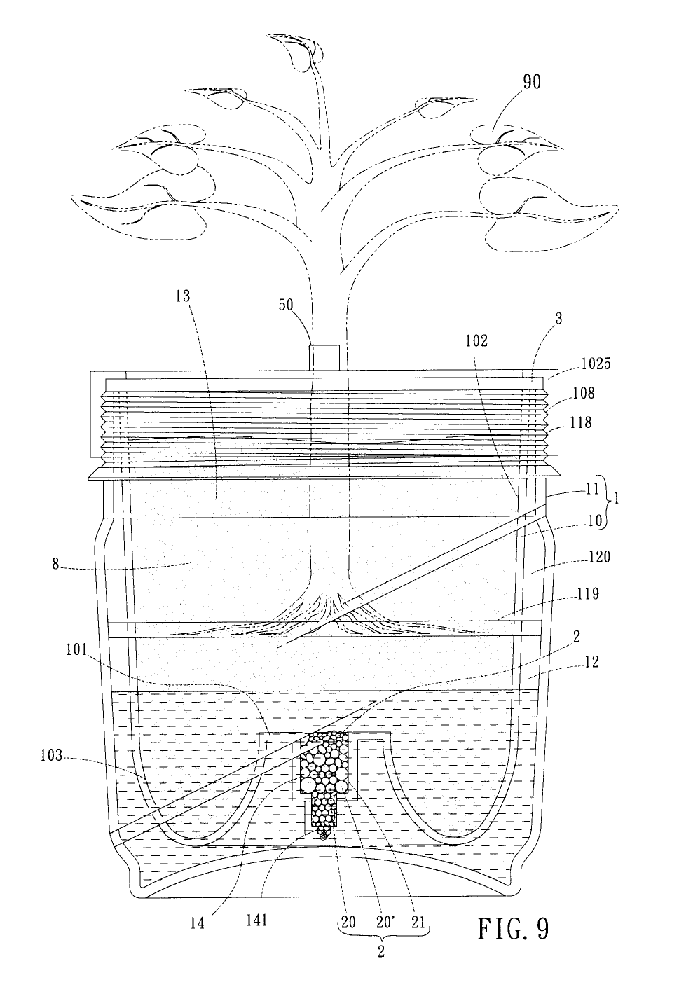

As show in FIGS. 5 to 9, the first embodiment of the pot assembly comprises a pot 1, a water-guide member 2, a water-proof unit 3 and a hollow hose 5. The pot 1 has an inner part 10 and a transparent outer part 11. The inner part 10 preferably is a transparent part. The inner part 10 has a first connection portion 108 which is located in the outside of the recessed space 13 of the inner part 10 (the outside of the periphery 102 or the annular surface 1025 located close to the periphery 102 as shown in FIG. 5), so that the first connection portion 108 is connected with the second connection portion 118 of the outer part 11 to locate the outer part 11 on outside of the inner part 10. A hollow area 12 is defined between the inner and outer parts 10, 11. The water-proof unit 3 is clamped between the inner part 10 and the outer part 11 so as to seal a top portion 120 of the hollow area 12. The recessed space 13 is defined between the inner bottom 101, the periphery 102 and the U-shaped inside 103 of the inner part 10. The inner part 10 has a protrusion extending from the inner bottom 101 and surrounded by the annular U-shaped inside 103. The recess 14 may include one stage or multiple stages is defined in the protrusion on the inner bottom 101 and more than one hole 141 is defined through the lower end of the recess 14 of the inner bottom 101 so that the inside of the recess 14 or the space 13 communicates with the hollow area 12. An end of the water-guide member 2 extends through the hole 141 and the water-guide member 2 comprises multiple particles 20, 20′. In other words, the end of the water-guide member 2 extends to the bottom of the hole 141 or protrudes from the bottom of the hole 141. Preferably, the end of the water-guide member 2 extends over the bottom of the hole 141 and reaches into the hollow area 12. The lowest position of the recess 14 or the hole 141 is located at the inside of the horizontal line of the lowest position of the U-shaped inside 103, or slightly protrudes beyond the inside of the horizontal line of the lowest position of the U-shaped inside 103 about 10 mm, so that the recess 14 or the hole 141 is hidden. The connection between the first and second connection portions 108, 118 can be threaded connection, or rotatable engagement. The first connection portion 108 can be threads, rails, slots or guide ridges. The outer part 11 is a transparent and recessed part and has the second connection portion 118 which is connected to the first connection portion 108 of the inner part 10. The outer part 11 has an over-flow index area 119 which is located on the outside or the inside of the outer part 11. The over-flow index area 119 is integrally formed with the outer part 11, or the over-flow index area 119 is connected to the outer part 11 after the over-flow index area 119 and the outer part 11 are individually made, the connection is made by gluing, coloring, transferring printing, printing machining so that the users can check the highest water level by visualization. The over-flow index area 119 can be located in longitudinal or altitude direction and can be convex, concaved, patterns, or color strips. The second connection portion 118 can be threads, rails, slots or guide ridges.

The water-supply unit 15 can be connected to the inner part 10 or the outer part 11 and communicates with the hollow area 12 between the inner and outer parts 10, 11. The seal unit 4 seals an end of the water-supply unit 15, and the sealing member 45 is located between the seal unit 4 and the water-supply unit 15.

The water-guide member 2 is described hereinbefore and will not be described here.

The water-proof unit 3 is resilient and is connected to the top of the inner part 10 or the periphery 102 of the inner part 10, or the outside of the annular surface 1025 of the inner part 10, or the top of the outer part 11, or the outside of the outer part 11. By this arrangement, the inner top surface of the inner part 10 and the outer top surface of the outer part 11 are clamped between the top and bottom ends of the water-proof unit 3. Therefore, the top portion 120 of the hollow area 12 between the inner and outer parts 10, 11 is sealed.

The hollow hose 5 is connected to the inner part 10 or the outer part 11, wherein the top end 50 of the hollow hose 5 communicates with outside of the hollow area 12 and the lower end 51 of the hollow hose 5 communicates with the hollow area 12. The lowest position of the lower end 51 is lower than the highest position of the top end of the water-guide member 2 in the recess 14, in other words, the highest position of the top end of the water-guide member 2 is higher than the lowest position of the lower end 51, so that air of outside of the hollow area 12 is in communication with the interior of the hollow area 12. The hollow hose 5 is integrally formed with the inner part 10 or the outer part 11, or the hollow hose 5 is individually connected to the inner part 10 or the outer part 11.

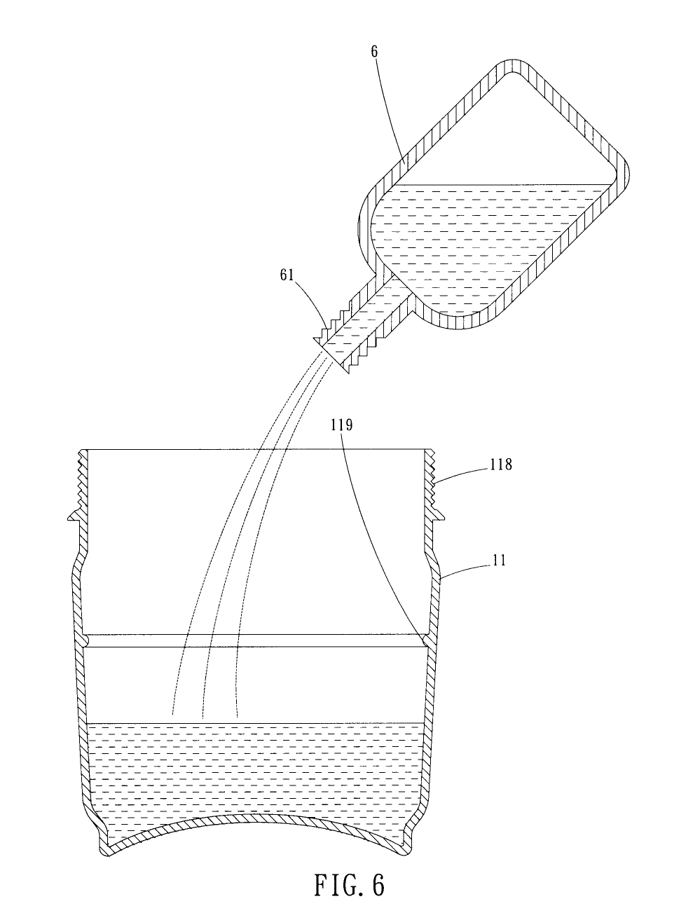

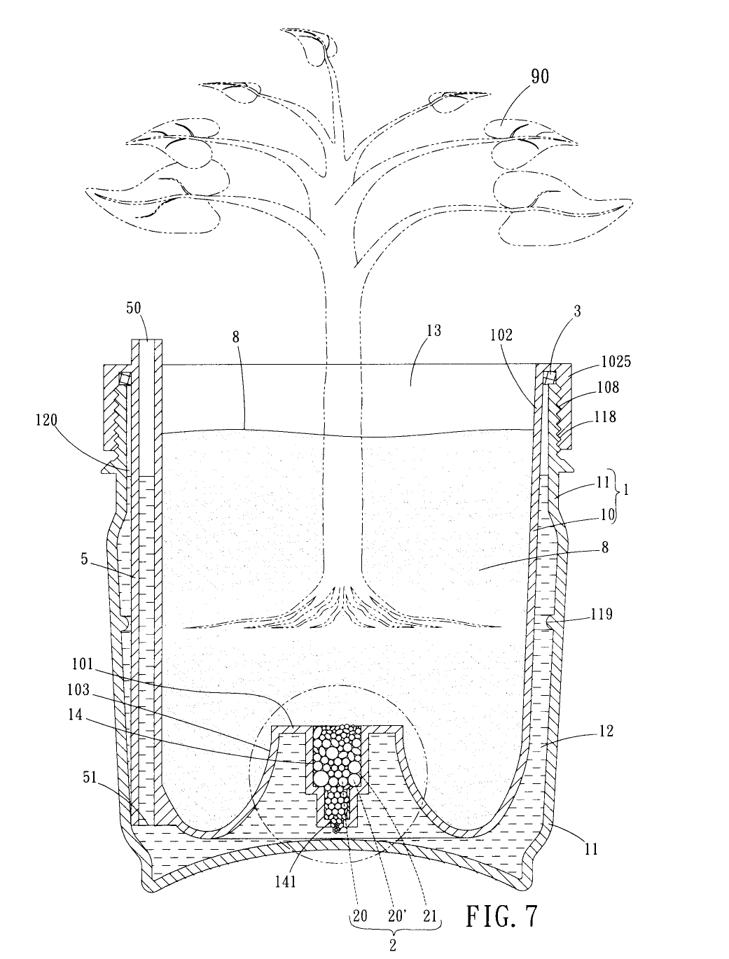

When in use, the metal water-guide member 2 composed of multiple metal particles 20, 20′ made by way of sintering is installed in the recess 14 of the transparent inner part 10 so that the other end of the water-guide member 2 is located adjacent to the conjunction portion between the hole 141 and the hollow area 12. The soil 8 and the plant 9 are put in the space 13 and supply water into the transparent outer part 11 as shown in FIG. 6 until the water surface reaches the maximum position of the over-flow index area 119. The water cannot be added to exceed the maximum position of the over-flow index area 119 to avoid the water over the maximum position of the over-flow index area 119 from being pushed by part of the inner part 10 so that the water overflows from the hollow area which is not yet sealed and out from the outer part 11. The water-guide member 2, the soil 8, the plant 9 and the first connection portion 108 of the inner part 10 are connected to the second connection portion 118 of the outer part 11 by the threads as shown in FIG. 5. The threaded connection is made to let the top end of the outer part 11 deforms the water-proof unit 3, which means that the water-proof unit 3 is firmly clamped between the inner top end of the inner part 10 and the outer top end of the outer part 11. Therefore, the top portion 120 of the hollow area 12 is sealed and the water surface is able to move upward to the hollow area 12 and the proper height of the hollow hose 5 as shown in FIG. 7.

The top portion 120 of the hollow area 12 between the inner and outer parts 10, 11 is sealed (means the area between the second connection portion 118 of the outer part 11 and the hole 141, or the area between the second connection portion 118 of the outer part 11 and the lower end 51 of the hollow hose 5 is sealed). The water in the hollow hose 5 is affected by the atmospheric pressure and the gravity, and the lower end of the water-guide member 2 reaches the hollow area 12 to have capillary action and the soil 8 absorbs the water, so that the water surface first lowers to the lower end 51 (means water molecular is filled in the soil 8 at the top portion of the water-guide member 2 and the hollow area 2). Some of the water molecular moves upward via the water-guide member 2 by the capillary action and is absorbed by the soil 8. If the soil 8 continuously absorbs the water in the hollow area 12, because some of the dried soil 8 absorbs the water first, the water molecular moves upward from the hollow area 12. The pressure of the top portion 120 of the hollow area 12 is slightly lower than one atmospheric pressure, so that the atmospheric pressure enters into the top portion 120 of the hollow area 12 via the hollow hose 5 to keep the water in the hollow area 12 moving toward the soil 8 until the humidity of the soil 8 reaches a balance condition.

When the water molecular in the soil 8 is absorbed by the root of the plant 9 or volatized, the water molecular in the hollow area 12 still continuously moves to the soil 8 by the capillary action and siphoning action so that the water surface in the hollow area 12 is lowered until the water surface cannot in contact with the other end of the water-guide member 2. This means extra water is needed to be supplied to the hollow area 12 and the water in the hollow area 12 can maintain the humidity of the soil 8. Therefore, the owners are allowed to travel away for a period of time while the plant 9 is still supplied with water.

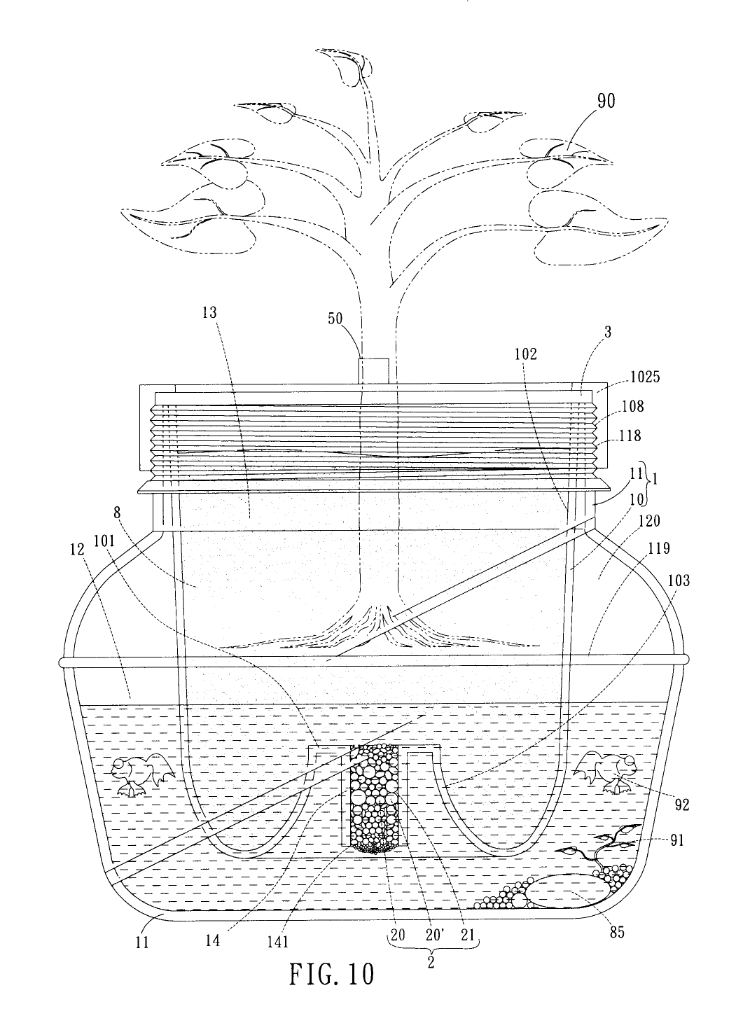

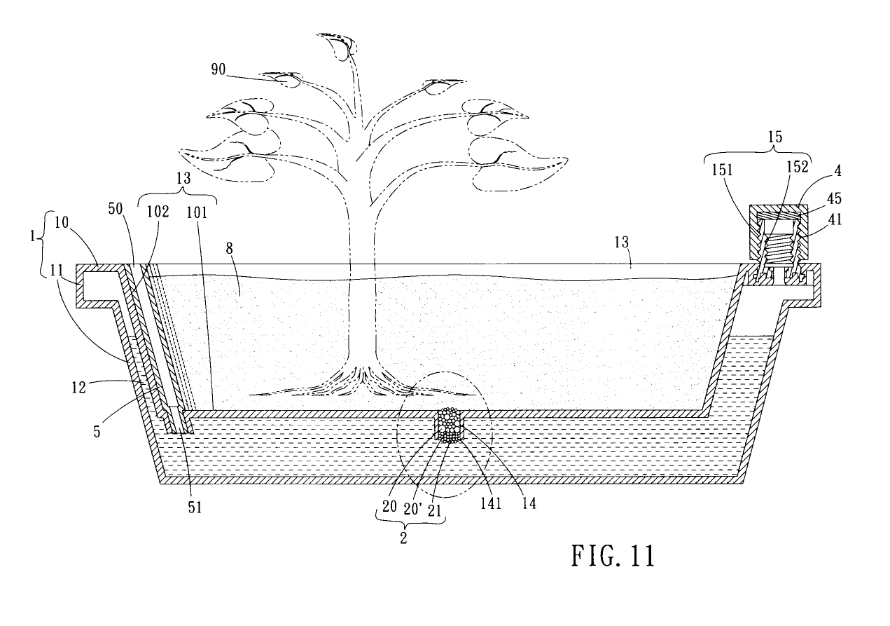

FIG. 10 shows the second embodiment of the present invention, wherein decoration pieces 85, aquatic plants 91 and aquatic animals 92 can be raised in the hollow area 12 between the transparent inner and outer parts 10, 11, light directly enters to the hollow area 12 so that photosynthesis can be made by the aquatic plants 91 and generates oxygen for the aquatic animals 92, such that an ecosystem is build. The owners can check the highest water surface and the humidity of the soil 8, and observe the growth of the aquatic plants 91 and the aquatic animals 92. The ecosystem together with the decoration pieces 85 can improve the mood of the rooms.

FIG. 13 shows the third embodiment of the present invention, wherein the lower end 51 of the hollow hose 5 is directly inserted into the inner bottom 101 in the space 13 of the inner part 10 (means the hollow hose 5 connected to the proper position of the inner part 10 or the outer part 11 is included in the scope of the invention), the lower end of the hollow hose 5 reaches the hollow area 12 so that air communicates between the inside and outside of the hollow area 12.

While we have shown and described the embodiment in accordance with the present invention, it should be clear to those skilled in the art that further embodiments may be made without departing from the scope of the present invention.

What is claimed is:

1. A pot assembly comprising:
a pot having an inner part and an outer part which supports the inner part, a hollow area defined between the inner and outer parts, an inner bottom and a periphery of the inner part define a recessed space, at least one hole located a position of the space and communicating with the hollow area;
a water-guide member comprising multiple particles and irregular paths defined between adjacent particles, the water-guide member located at traces between the space and the at least one hole.

2. The pot assembly as claimed in claim 1, wherein the water-guide member comprises multiple metal particles which are made by way of sintering, irregular paths are defined between adjacent particles, an end of the water-guide member extends through the at least one hole and reaches into the hollow area.

3. The pot assembly as claimed in claim 2, wherein the metal particles are copper particles.

4. The pot assembly as claimed in claim 1, wherein the water-guide member comprises multiple ceramic particles which are made by way of sintering, irregular paths are defined between adjacent particles, an end of the water-guide member extends through the at least one hole and reaches into the hollow area.

5. The pot assembly as claimed in claim 1, wherein the water-guide member comprises multiple stone particles which are made by way of sintering, irregular paths are defined between adjacent particles, an end of the water-guide member extends through the at least one hole and reaches into the hollow area.

6. A pot assembly comprising:
a pot having an inner part and an outer part which supports the inner part, the inner part having a first connection portion which is located in an outside of a recessed space of the inner part, the first connection portion connected with a second connection portion of the outer part, a hollow area defined between the inner and outer parts, the recessed space being defined between an inner bottom and a periphery of the inner part, at least one hole located at a position of the space and communicating with the hollow area;
the outer part being a recessed transparent part and having the second connection portion which is connected to the first connection portion of the inner part;
a water-proof unit being clamped between the inner part and the outer part 11 so as to seal a top portion of the hollow area; and
a water-proof unit clamped between the inner and outer parts so as to seal the top portion of the hollow area;
a hollow hose having a top end communicating with outside of the hollow area and a lower end of the hollow hose communicating with the hollow area, air of outside of the hollow area being in communication with an interior of the hollow area.

7. The pot assembly as claimed in claim 6, wherein the hollow hose is integrally connected to the inner part or the outer part.

8. The pot assembly as claimed in claim 7, wherein the outer part has an over-flow index area.

9. The pot assembly as claimed in claim 8, wherein the over-flow index area is located on an outside or an inside of the outer part.

10. The pot assembly as claimed in claim 9, wherein the over-flow index area is integrally formed with the outer part.

11. The pot assembly as claimed in claim 9, wherein the over-flow index area is connected to the outer part after the over-flow index area and the outer part are individually made, the connection is made by gluing or coloring.

12. The pot assembly as claimed in claim 10, wherein the second connection portion of the outer part is threads and the first connection portion of the inner part is threads, the first and second connection portions are threadedly connected to each other so as to define the hollow area between the inner and outer parts.

13. The pot assembly as claimed in claim 12, wherein the inner part has a recess defined in the inner bottom and extends downward, a hole is defined through a lower end of the recess of the inner bottom.

14. The pot assembly as claimed in claim 12, wherein the inner part has a protrusion extending from the inner bottom and surrounded by an annular U-shaped inside, a recess is defined in the protrusion on the inner bottom and a hole is defined through a lower end of the recess of the inner bottom so that inside of the recess is located outside of the water-guide member and the water-guide member is located on a water path between soil in the space and the hole, a top edge of the water-guide member in the space is higher than the lower end of the hollow hose.

15. The pot assembly as claimed in claim 14, wherein an end of the water-guide member extends through the hole and reaches to the hollow area between the inner and outer parts, the water-guide member comprises multiple copper particles which are made by way of sintering, irregular paths are defined between adjacent particles,

16. The pot assembly as claimed in claim 15, wherein the inner part or the outer part has a water-supply unit which communicates with the hollow area between the inner and outer parts, a seal unit seals an end of the water-supply unit, a sealing member is located between the seal unit and the water-supply unit.

17. The pot assembly as claimed in claim 6, wherein the hollow hose is integrally connected to the inner part or the outer part.

18. The pot assembly as claimed in claim 17, wherein the outer part has an over-flow index area.

19. The pot assembly as claimed in claim 18, wherein the over-flow index area is located on an outside or an inside of the outer part.

20. The pot assembly as claimed in claim 19, wherein the over-flow index area is integrally formed with the outer part.

21. The pot assembly as claimed in claim 19, wherein the over-flow index area is connected to the outer part after the over-flow index area and the outer part are individually made, the connection is made by gluing or coloring.

22. The pot assembly as claimed in claim 21, wherein the second connection portion of the outer part is threads and the first connection portion of the inner part 10 is threads, the first and second connection portions are threadedly connected to each other so as to define the hollow area between the inner and outer parts.

23. The pot assembly as claimed in claim 22, wherein the inner part has a recess defined in the inner bottom and extends downward, a hole is defined through a lower end of the recess of the inner bottom.

24. The pot assembly as claimed in claim 22, wherein the inner part has a protrusion extending from the inner bottom and surrounded by an annular U-shaped inside, a recess is defined in the protrusion on the inner bottom and a hole is defined through a lower end of the inner bottom so that inside of the recess is located outside of the water-guide member and the water-guide member is located on a water path between soil in the space and the hole, a top end of the water-guide member in the space is higher than the lower end of the hollow hose.

25. The pot assembly as claimed in claim 14, wherein an end of the water-guide member extends through the hole and reaches to the hollow area between the inner and outer parts, the water-guide member comprises multiple copper particles which are made by way of sintering, irregular paths are defined between adjacent particles,

26. The pot assembly as claimed in claim 25, wherein the inner part or the outer part has a water-supply unit which communicates with the hollow area between the inner and outer parts, a seal unit seals an end of the water-supply unit, a sealing member is located between the seal unit and the water-supply unit.
